(19) United States
(12) Patent Application Publication
(10) Pub. No.: US 2024/0401991 A1
(43) Pub. Date: Dec. 5, 2024

(54) SENSOR MOUNTING STRUCTURE

(71) Applicant: Yazaki Corporation, Tokyo (JP)

(72) Inventors: Shinpei KATO, Makinohara-shi (JP); Shingo NOMOTO, Makinohara-shi (JP); Keisuke YAMAUCHI, Makinohara-shi (JP); Shimpei ANDO, Makinohara-shi (JP); Tadashi OGAWA, Makinohara-shi (JP)

(73) Assignee: Yazaki Corporation, Tokyo (JP)

(21) Appl. No.: 18/656,764

(22) Filed: May 7, 2024

(30) Foreign Application Priority Data
Jun. 3, 2023 (JP) 2023-091354

(51) Int. Cl. G01D 11/30; G01D 11/16

(52) U.S. Cl. CPC G01D 11/30; G01D 11/16

(57) ABSTRACT

A sensor mounting structure includes a sensor and a sensor receiving section including a receiving lock portion protruding from a seat surface to be locked to a portion of a collar section, wherein the collar section of the sensor includes: a sensor lock portion; and an interference avoiding portion in an overlapping portion of the collar section, wherein when the sensor main body is inserted in the sensor insertion hole in an incorrect pose, the collar section overlaps with the receiving lock portion in the overlapping portion, wherein the incorrect pose is offset from a normal pose around the center axis, wherein in the normal pose, the sensor lock portion is locked to the receiving lock portion, wherein the interference avoiding portion avoids interference of the collar section with the receiving lock portion along a direction of insertion of the sensor main body into the sensor insertion hole.

### BACKGROUND OF THE INVENTION

### Technical Field

The present invention relates to a sensor mounting structure for mounting a sensor to a sensor receiving section.

### Background Art

Conventionally, a sensor mounting structure is known which is configured for mounting a sensor, such as a temperature sensor, to a sensor receiving section, wherein the sensor receiving section is included in a device for which measurement such as temperature measurement is performed (see e.g. Patent Document 1). In the sensor mounting structure according to Patent Document 1, a thread is formed in an outer circumferential surface of the sensor, wherein the sensor is configured to be screwed into a threaded hole in the sensor receiving section for mounting the sensor.

### CITATION LIST

### Patent Literature

Patent Document 1: EP 2485023 A2

### SUMMARY OF THE INVENTION

The sensor mounting structure according to Patent Document 1 is configured as screw fastening structure, wherein the sensor has a mounted pose which is substantially uniquely determined. For this reason, mismounting may occur with low likelihood. On the other hand, the sensor mounting structure requires e.g. strictly exact torque management for screw fastening, which may result in a problem of low workability: For sensor mounting structures which are not based on screw fastening, mismounting may occur in such a sensor mounting structure. Such mismounting may cause a damage to a sensor and/or sensor receiving section.

Therefore, the present invention is focused on the above-mentioned problems, and an objective of the present invention is to provide a sensor mounting structure which allows a sensor to be mounted with better workability while suppressing damages even in the case of mismounting.

In order to achieve this objective, a sensor mounting structure includes: a sensor including a bar-shaped sensor main body and a collar section, the collar section overhanging in a thickness direction of the sensor main body from an outer circumferential surface of the sensor main body at a middle location of the sensor main body in its longitudinal direction; and a sensor receiving section including a sensor insertion hole, the sensor insertion hole being configured for inserting the sensor main body therein so as to allow the sensor main body to be rotated around a center axis of the sensor main body, wherein the sensor receiving section is configured to support the sensor with the sensor main body being inserted in the sensor insertion hole to bring the collar section into contact with a seat surface around the sensor insertion hole, wherein the sensor receiving section includes a receiving lock portion protruding from the seat surface, the receiving lock portion being configured to be locked to a portion of the collar section, wherein the collar section of the sensor includes: a sensor lock portion configured to be locked to the receiving lock portion; and an interference avoiding portion in an overlapping portion of the collar section, wherein when the sensor main body is inserted in the sensor insertion hole in an incorrect pose, the collar section is configured to overlap with the receiving lock portion in the overlapping portion, wherein the incorrect pose is offset from a normal pose by a predetermined angle around the center axis, wherein in the normal pose, the sensor lock portion is configured to be locked to the receiving lock portion, wherein the interference avoiding portion has a shape for avoiding interference of the collar section with the receiving lock portion along a direction of insertion of the sensor main body into the sensor insertion hole.

Such a sensor mounting structure allows a sensor to be mounted with better workability while suppressing damages even in the case of mismounting.

### BRIEF DESCRIPTION OF THE DRAWINGS

FIG. 1 shows a perspective view of a sensor mounting structure according to an embodiment;

FIG. 2 shows a perspective view of a sensor in the sensor mounting structure according to FIG. 1;

FIG. 3 shows a perspective view of a sensor receiving section in the sensor mounting structure according to FIG. 1;

FIG. 4 shows a perspective view of the sensor mounting structure from a back side of the sensor receiving section opposite to its seat surface, wherein this figure shows how anti-removal protrusions as shown in FIGS. 1 and 2 pass through protrusion passages as shown in FIGS. 1 and 3 to serve for preventing removal;

FIG. 5 shows a sectional view of the sensor mounting structure along a center axis of a sensor main body with its section plane extending through a pair of anti-removal protrusions as shown in FIGS. 1 and 2, wherein this figure shows how the anti-removal protrusions pass through the protrusion passages as shown in FIGS. 1 and 3 to serve for preventing removal;

FIG. 6 shows a reference example for comparison with the sensor mounting structure according to FIGS. 1 to 5 for the purpose of explanation how it can limit damages to the sensor and/or sensor receiving section in the case of mismounting in an incorrect pose; and

FIG. 7 shows how damages to the sensor and/or sensor receiving section are limited in the sensor mounting structure according to FIGS. 1 to 5 in the case of mismounting, in comparison with the reference example according to FIG. 6.

### DETAILED DESCRIPTION OF THE PREFERRED EMBODIMENTS

Hereinafter, an embodiment of a sensor mounting structure will be described.

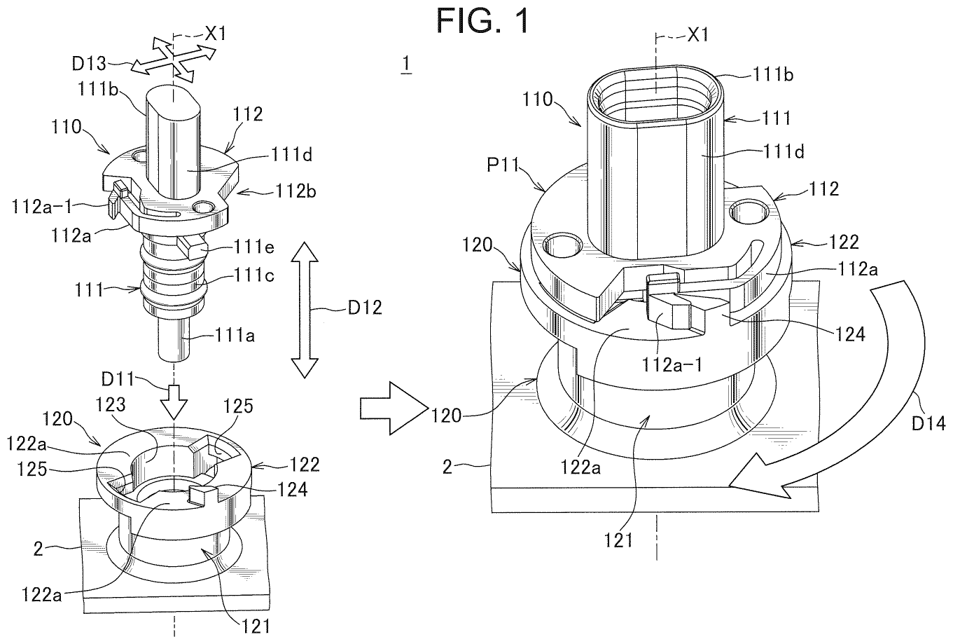

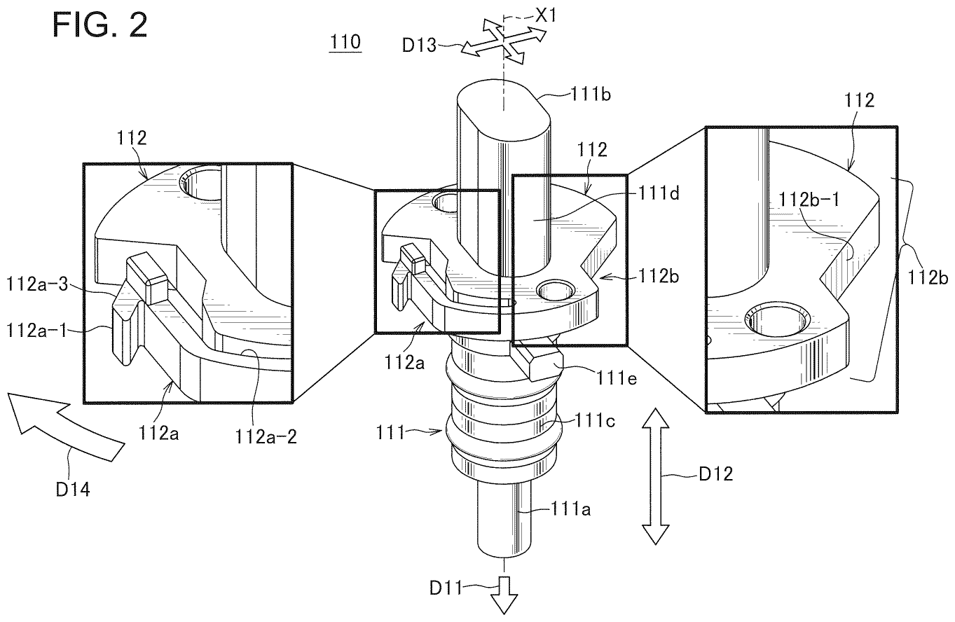

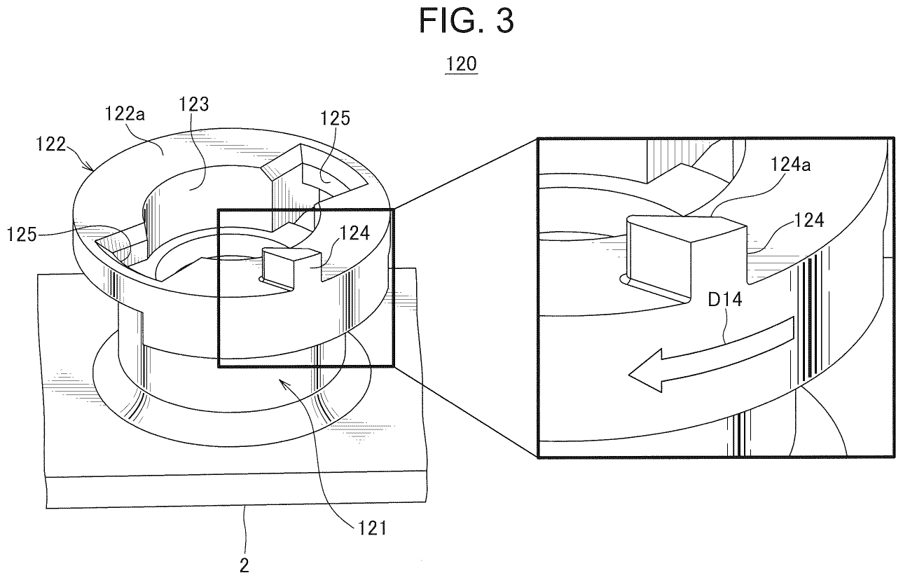

FIG. 1 shows a perspective view of a sensor mounting structure according to an embodiment. FIG. 2 shows a perspective view of a sensor in the sensor mounting structure according to FIG. 1. FIG. 3 shows a perspective view of a sensor receiving section in the sensor mounting structure according to FIG. 1.

A sensor mounting structure 1 according to the present embodiment has a structure in which a sensor 110 is mounted to a sensor receiving section 120 with a sensor insertion hole 123 formed therein, wherein the sensor 110 includes a bar-shaped sensor main body 111 and may be used e.g. as a temperature sensor. The sensor 110 includes the sensor main body 111 and a collar section 112. The sensor receiving section 120 is a cylindrical portion at an outer wall 2, for example an outer wall of a device for which measurement such as temperature measurement is performed. The sensor receiving section 120 includes a tube main body portion 121 and a seat surface portion 122, wherein the seat surface portion 122 is formed in a thick disc shape and the sensor insertion hole 123 extends from the seat surface portion 122 through the tube main body portion 121 to penetrate the outer wall 2. The sensor 110 includes a detecting section 111a on a forward end side of the sensor main body 111 in a direction of insertion D11 into the sensor insertion hole 123, wherein the sensor 110 is configured to be mounted to the sensor receiving section 120 so that the detecting section 111a is inserted through the outer wall 2 to reach the inside of e.g. the device. Furthermore, an end of the sensor main body 111 opposite to the detecting section 111a is configured as a knob portion 111b, wherein the knob portion 111b is configured to be gripped by an operator for mounting the sensor 110.

The bar-shaped sensor main body 111 includes a middle section 111c, wherein the detecting section 111a and the middle section 111c are configured as cylindrical portions with a smaller diameter and a larger diameter, respectively. On the other hand, the knob portion 111b is configured as a flat portion which can be easily held by the operator, wherein the knob portion 111b has an ellipsoidal cross section intersecting a center axis X1 of the sensor main body 111.

The collar section 112 of the sensor 110 is a substantially disc-shaped portion which overhangs in a thickness direction D13 of the sensor main body 111 from an outer circumferential surface 111d of the sensor main body 111 at a middle location of the sensor main body 111 in its longitudinal direction D12.

The seat surface portion 122 of the sensor receiving section 120 defines a seat surface 122a around the sensor insertion hole 123, wherein the collar section 112 is configured to come into contact with the seat surface 122a when inserting the sensor main body 111 into the sensor insertion hole 123. The sensor main body 111 is inserted into the sensor insertion hole 123 so as to allow the sensor main body 111 to be rotated around a center axis X1 of the sensor main body 111, wherein the sensor receiving section 120 is configured to support the sensor 110 with the sensor main body 111 being inserted in the sensor insertion hole 123 to bring the collar section 112 into contact with the seat surface 122a. Furthermore, the sensor receiving section 120 includes a receiving lock portion 124 protruding from the seat surface 122a, the receiving lock portion 124 being configured to be locked to a sensor lock portion 112a which is a portion of the collar section 112 and will be described below.

On the other hand, the collar section 112 of the sensor 110 includes the sensor lock portion 112a and an interference avoiding portion 112b.

The sensor lock portion 112a is configured to be locked to the receiving lock portion 124 when the sensor 110 is mounted in a normal pose P11 as shown in FIG. 1. According to the present embodiment, the sensor lock portion 112a is configured as a cantilever-shaped portion as described below, wherein the cantilever-shaped portion includes a locking hook 112a-1 on a free end of this portion, the locking hook 112a-1 being configured to be locked to the receiving lock portion 124.

For mounting the sensor 110 to the sensor receiving section 120, the sensor main body 111 is first inserted into the sensor insertion hole 123 with the locking hook 112a-1 of the sensor lock portion 112a being spaced from the receiving lock portion 124 around the center axis X1. Subsequently, the locking hook 112a-1 is rotated in a rotational direction of locking D14 to be locked to the receiving lock portion 124 and to thus reach the normal pose P11, wherein in the rotational direction of locking D14, the locking hook 112a-1 is moved toward the receiving lock portion 124.

The cantilever-shaped sensor lock portion 112a—which includes the locking hook 112a-1 formed at the free end—is formed by providing a cut-in portion 112a-2, wherein the cut-in portion 112a-2 extends along an outer circumference of the collar section 112 from a forward side to a backward side in the rotational direction of locking D14. The sensor lock portion 112a includes a fixed end on the backward side and the free end on the forward side in the rotational direction of locking D14, wherein the locking hook 112a-1 is formed at the free end. When the sensor 110 is rotated in the rotational direction of locking D14 after inserting the sensor main body 111, the sensor lock portion 112a is bent toward the center axis X1 and the locking hook 112a-1 thus crosses over the receiving lock portion 124 to reach the normal pose P11. In the normal pose P11, the locking hook 112a-1 is locked to the receiving lock portion 124.

In addition, a sensor guide slope surface 112a-3 is formed on forward side of the locking hook 112a-1 in the rotational direction of locking D14, and a receiving guide slope surface 124a is formed on a backward side of the receiving lock portion 124 in the rotational direction of locking D14. When the sensor 110 is rotated in the rotational direction of locking D14, the sensor guide slope surface 112a-3 and the receiving guide slope surface 124a slide on each other to guide the locking hook 112a-1 crossing over the receiving lock portion 124.

Furthermore, the interference avoiding portion 112b provided in the collar section 112 is configured to avoid interference of the collar section 112 with the receiving lock portion 124 when the sensor main body 111 is inserted in an incorrect pose, wherein the incorrect pose is offset from the normal pose P11 by a predetermined angle around the center axis X1. This interference avoiding portion 112b is formed in an overlapping portion of the collar section 112, wherein when the sensor main body 111 is inserted in the incorrect pose, the collar section 112 overlaps with the receiving lock portion 124 in the overlapping portion. Furthermore, the interference avoiding portion 112b is formed in a shape for avoiding interference of the collar section 112 with the receiving lock portion 124 along the direction of insertion D11 of the sensor main body 111 into the sensor insertion hole 123. More specifically, the interference avoiding portion 112b has a recess 112b-1 which is recessed in an L-shape from the outer circumference of the collar section 112 toward the center axis X1 of the sensor main body 111, wherein the recess 112b-1 is configured to receive the receiving lock portion 124 inside the recess 112b-1 in the incorrect pose. According to the present embodiment, the incorrect pose is an inverted pose which is offset by an angle of 180 degrees from the normal pose P11 around the center axis X1, as described in more details below. Accordingly, the recess 112b-1 of the interference avoiding portion 112b is configured to include a portion which is offset by an angle of 180 degrees from the sensor lock portion 112a around the center axis X1.

According to the present embodiment, the sensor main body 111 further includes one pair of anti-removal protrusions 111e, wherein the anti-removal protrusions 111e are located further forward in the direction of insertion D11 than the collar section 112 and protrude from the outer circumferential surface 111d in the thickness direction D13. On the other hand, the sensor receiving section 120 includes one pair of protrusion passages 125, wherein when inserting the sensor main body 111, the protrusion passages 125 are configured to allow the pair of anti-removal protrusions 111e to pass therethrough in a one-to-one manner.

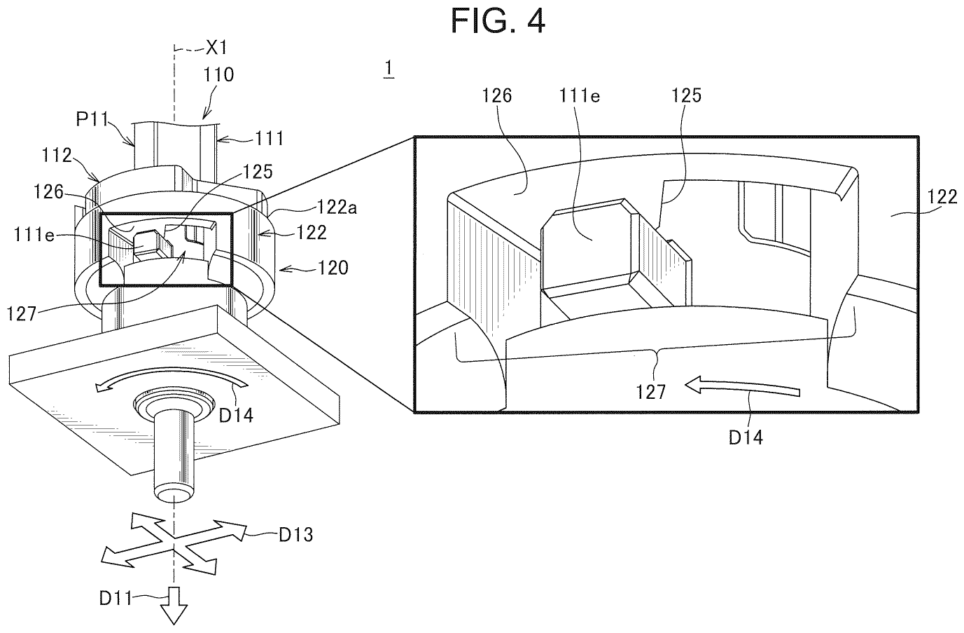

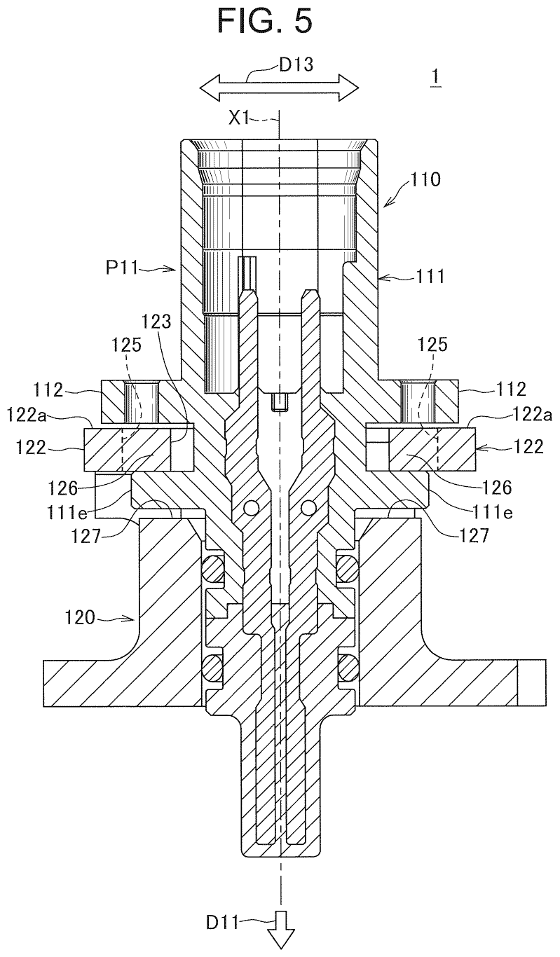

FIG. 4 shows a perspective view of the sensor mounting structure from a back side of the sensor receiving section opposite to the seat surface, wherein this figure shows how the anti-removal protrusions as shown in FIGS. 1 and 2 pass through the protrusion passages as shown in FIGS. 1 and 3 to serve for preventing removal. FIG. 5 shows a sectional view of the sensor mounting structure along the center axis of the sensor main body with its section plane extending through the pair of anti-removal protrusions as shown in FIGS. 1 and 2, wherein this figure shows how the anti-removal protrusions pass through the protrusion passages as shown in FIGS. 1 and 3 to serve for preventing removal.

As described above, the pair of anti-removal protrusions 111e—which protrude from the bar-shaped sensor main body 111 of the sensor 110 in the thickness direction D13—is located further forward in the direction of insertion D11 than the collar section 112. The pair of anti-removal protrusions 111e is further configured as prismatic protrusions which are offset from each other by an angle of 180 degrees around the center axis X1 of the sensor main body 111.

As described above, the sensor mounting structure 1 is configured such that the sensor main body 111 is inserted into the sensor insertion hole 123 and then the sensor 110 is rotated in the rotational direction of locking D14 to reach the normal pose P11. The sensor receiving section 120 includes the pair of protrusion passages 125, wherein when inserting the sensor main body 111 with the locking hook 112a-1 of the sensor lock portion 112a being spaced from the receiving lock portion 124 around the center axis X1, the protrusion passages 125 are configured to allow the pair of anti-removal protrusions 111e to pass therethrough in a one-to-one manner. The pair of protrusion passages 125 is formed by cutting into the disc-shaped seat surface portion 122 radially outwardly from an inner circumferential edge of the sensor insertion hole 123. When the sensor 110 reaches the normal pose P11, the anti-removal protrusions 111e pass through the protrusion passages 125, and are thereafter offset from the protrusion passages 125 to be rotationally moved in the rotational direction of locking D14. In this manner, partial seat surface walls 126 are clamped between the anti-removal protrusions 111e and the collar section 112 so that the anti-removal protrusions 111e will serve for preventing removal, wherein the partial seat surface walls 126 are part of the sensor receiving section 120. Each of the partial seat surface walls 126 is an outer wall section which includes a portion of the seat surface 122a of the seat surface portion 122, the portion being adjacent to a forward side of the protrusion passage 125 in the rotational direction of locking D14. Furthermore, an accommodating space 127 is formed on a back side of each partial seat surface wall 126 opposite to the seat surface 122a, wherein after a corresponding one of the anti-removal protrusions 111e has passed through the protrusion passage 125, the accommodating space 127 is configured to accommodate this anti-removal protrusion 111e so as to allow the anti-removal protrusion 111e to be rotationally moved in the rotational direction of locking D14.

With the sensor mounting structure 1 as described above, the sensor 110 is mounted to the sensor receiving section 120 by inserting the sensor main body 111 into the sensor insertion hole 123 and by locking the sensor lock portion 112a to the receiving lock portion 124. Because no screw fastening is used in the sensor mounting structure 1, torque management is not necessary, and it is possible to mount the sensor 110 with better workability. Furthermore, the sensor mounting structure 1 enables damages to the sensor 110 and/or sensor receiving section 120 as a location for mounting the sensor 110 to be suppressed by the means of the interference avoiding portion 112b of the collar section 112 in the case of mismounting in the incorrect pose which is offset from the normal pose P11 around the center axis X1, which will be described below:

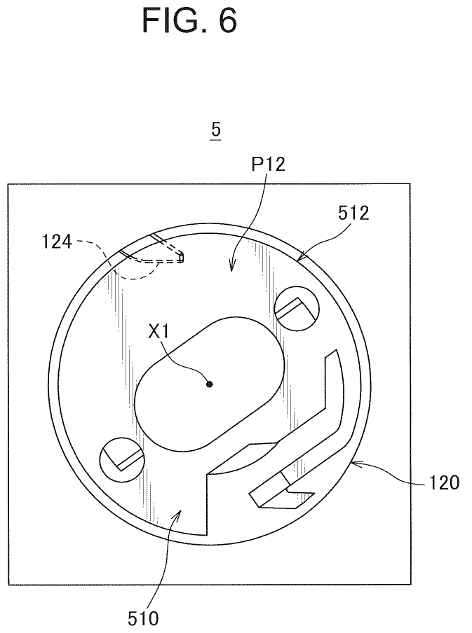

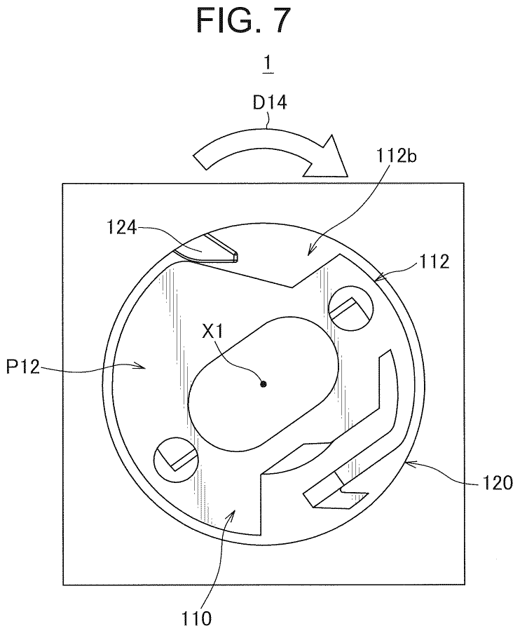

FIG. 6 shows a reference example for comparison with the sensor mounting structure according to FIGS. 1 to 5 for the purpose of explanation how it can limit damages to the sensor and/or sensor receiving section in the case of mismounting in the incorrect pose. Furthermore, FIG. 7 shows how damages to the sensor and/or sensor receiving section are limited in the sensor mounting structure according to FIGS. 1 to 5 in the case of mismounting, in comparison with the reference example according to FIG. 6. It is to be noted that in FIG. 6, similar elements/features are designated with same reference signs as those in FIGS. 1 to 5 and FIG. 7 (particularly FIG. 7), wherein corresponding description will be not repeated for such similar elements/features in the following description.

In a collar section 512, a sensor mounting structure 5 according to the reference example as shown in FIG. 6 does not include an interference avoiding portion 112b which is responsible for suppressing damages in the case of mismounting according to the above embodiment. Otherwise, the sensor mounting structure 5 according to the reference example includes similar features as the sensor mounting structure 1 according to the above embodiment. In the sensor mounting structure 5 according to the reference example, mismounting in an incorrect pose P12 may be caused similarly to the sensor mounting structure 1 according to the above embodiment, wherein the incorrect pose P12 is an inverted pose which is offset by an angle of 180 degrees from a normal pose P11 around a center axis X1. In this case, a receiving lock portion 124 of a sensor receiving section 120 may interfere with the collar section 512 of a sensor 510 in the sensor mounting structure 5 according to the reference example, which may result in damage to one or both of the receiving lock portion 124 and the collar section 512.

In contrary; the sensor mounting structure 1 is provided such that in the case of mismounting in the incorrect pose P12, the interference avoiding portion 112b enables interference of the receiving lock portion 124 of the sensor receiving section 120 with the collar section 112 of the sensor 110 to be avoided. With the sensor mounting structure 1 according to the above embodiment, damages to the sensor 110 and/or sensor receiving section 120 can be suppressed by avoiding such interference in the case of mismounting. In this manner, the above sensor mounting structure 1 allows the sensor 110 to be mounted with better workability while suppressing damages even in the case of mismounting.

According to the present embodiment, the interference avoiding portion 112b of the collar section 112 is a region for receiving the receiving lock portion 124 in the incorrect pose P12, inside the recess 112b-1. In the case of mismounting in the incorrect pose P12, this configuration enables the interference of the collar section 112 with the receiving lock portion 124 to be effectively avoided by receiving the receiving lock portion 124 inside the recess 112b-1 in the interference avoiding portion 112b.

In addition, according to the present embodiment, the sensor main body 111 is inserted into the sensor insertion hole 123 with the sensor lock portion 112a being spaced from the receiving lock portion 124, and thereafter, the sensor 110 is rotated in the rotational direction of locking D14 to reach the normal pose P11. With this configuration, the sensor 110 is mounted by two steps of operation, namely by insertion of the sensor main body 111 with the sensor lock portion 112a being spaced from the receiving lock portion 124, and then by rotation of the sensor 110 in the rotational direction of locking D14. Due to the mounting operation of the sensor 110 which is divided into two stages as described above, there are increased opportunities for the operator to notice mismounting in the incorrect pose P12 as compared to a structure with one step mounting, which may reduce occurrences of mismounting.

Furthermore, in a state of the sensor main body 111 being inserted into the sensor insertion hole 123 in the incorrect pose P12, the interference avoiding portion 112b according to the present embodiment interferes with the receiving lock portion 124 around the center axis X1 and thus limits rotation of the sensor 110 in the rotational direction of locking D14. With this configuration, the rotation of the sensor 110 in the rotational direction of locking D14 is limited in the case of mismounting, which allows the operator to notice mismounting more easily, whereby occurrences of mismounting may be further reduced.

According to the present embodiment, the sensor lock portion 112a is configured as a cantilever-shaped portion which includes the fixed end on the backward side and the free end on the forward side in the rotational direction of locking D14, wherein the locking hook 112a-1 for locking the receiving lock portion 124 thereto is formed at the free end. When the sensor 110 is rotated in the rotational direction of locking D14, the sensor lock portion 112a is bent toward the center axis X1 and the locking hook 112a-1 thus crosses over the receiving lock portion 124 to be locked to the receiving lock portion 124. In the case of the sensor 110 being correctly mounted in the normal pose P11, the above configuration enables the operator to perceive a click, wherein such perception of a click is caused by the locking hook 112a-1 which crosses over the receiving lock portion 124 and is locked to the receiving lock portion 124. Through perception of click or absence of the perception, the operator may notice mismounting more easily, whereby occurrences of mismounting may be further reduced.

Furthermore, when the sensor 110 is rotated in the rotational direction of locking D14, the sensor guide slope surface 112a-3 and the receiving guide slope surface 124a according to the present embodiment slide on each other to guide the locking hook 112a-1 crossing over the receiving lock portion 124. In this manner, a resistance for the locking hook 112a-1 crossing over the receiving lock portion 124 is reduced by the sensor guide slope surface 112a-3 and receiving guide slope surface 124a sliding on each other, whereby workability related to mounting the sensor 110 may be further improved.

Moreover, according to the present embodiment, the sensor main body 111 includes the pair of anti-removal protrusions 111e, and the sensor receiving section 120 includes the pair of protrusion passages 125 which are passed through by the anti-removal protrusions 111e in a one-to-one manner. Furthermore, the sensor receiving section 120 includes the accommodating spaces 127 for the anti-removal protrusions 111e, wherein one of the accommodating spaces 127 is formed on the back side of the partial seat surface wall 126 and adjacent to the forward side of each of the protrusion passages 125 in the rotational direction of locking D14. This configuration avoids mounting the sensor 110 in a pose which is different from a pose allowing the anti-removal protrusions 111e to pass through the protrusion passages 125, whereby occurrences of mismounting may be further reduced. Furthermore, according to the above configuration, the partial seat surface walls 126 adjacent to the respective protrusion passages 125 are clamped between the collar section 112 on the one hand and the anti-removal protrusions 111e positioned inside the accommodating spaces 127 on the other hand to prevent the sensor 110 from being removed, which allows the sensor 110 to be mounted to the sensor receiving section 120 in a stable manner.

Further, according to the present embodiment, one pair of anti-removal protrusions 111e is spaced from each other by an angle of 180 degrees around the center axis X1, wherein the sensor 110 takes the incorrect pose P12 as an inverted pose which is offset by an angle of 180 degrees from the normal pose P11 around the center axis X1. With this configuration, it is possible to prevent the the sensor 110 from being removed in a balanced manner by using a minimum number of anti-removal protrusions 111e, i.e., one pair of anti-removal protrusions 111e, which is disposed in rotationally symmetrical positions with respect to the center axis X1. Furthermore, the incorrect pose P12 has a large offset angle of 180 degrees relative to the normal pose P11, which enables occurrences of mismounting in the incorrect pose P12 to be further reduced.

It is to be noted that the above embodiment(s) merely demonstrates implementations which are representative for the sensor mounting structure. The sensor mounting structure is not limited thereto, and may be modified and implemented in various manners.

For example, the above embodiment shows, as an example for the sensor mounting structure, the sensor mounting structure 1 in which the sensor 110, e.g. for use as a temperature sensor, is intended to be mounted to the sensor receiving section 120, wherein the sensor receiving section 120 is provided in the outer wall 2, e.g. an outer wall of a device for which measurement such as temperature measurement is performed. However, the sensor mounting structure is not limited thereto, but a type of sensor and/or a location for installation of the sensor receiving section may be selected appropriately for each specific case, e.g. depending on a target to be detected.

Furthermore, the above embodiment shows, as an example for the sensor, the sensor 110 which includes the sensor main body 111 and the substantially disc-shaped collar section 112, wherein the sensor main body 111 is formed from the detecting section 111a with a smaller diameter, the middle section 111c with a larger diameter, and the flat knob portion 111b. By way of example, the above embodiment further shows the sensor receiving section 120 including the cylindrical tube main body portion 121 and the seat surface portion 122, wherein the seat surface portion 122 has a thick disc shape. However, the sensor and sensor receiving section are not limited thereto. Various portions and sections of the sensor may have any specific shape which allows the sensor to include a bar-shaped sensor main body and a collar section overhanging therefrom in the thickness direction of the sensor main body: Similarly, various portions and sections of the sensor receiving section may have any specific shape which allows the sensor receiving section to include a sensor insertion hole for inserting the sensor main body therein in a rotatable manner and to support the sensor with the sensor main body being inserted to bring the collar section into contact with the seat surface around the sensor insertion hole.

The above embodiment further shows, an example for the interference avoiding portion, the interference avoiding portion 112b for receiving the receiving lock portion 124 inside the recess 112b-1 in the incorrect pose, wherein the recess 112b-1 is recessed from the outer circumference of the collar section 112 toward the center axis X1. However, the interference avoiding portion is not limited thereto, but may be configured as an indentation recessed in a thickness direction of the collar section for receiving the receiving lock portion in the incorrect pose inside the indentation, or a region e.g. with a through hole extending through the collar section in the thickness direction for receiving the receiving lock portion in the incorrect pose inside the through hole. This means that the interference avoiding portion may have e.g. any shape which avoids interference with the receiving lock portion in the direction of insertion of the sensor main body in the incorrect pose. However, interference in the incorrect pose P12 can be avoided effectively by the interference avoiding portion 112b with the recess 112b-1 recessed from the outer circumference of the collar section 112 toward the center axis X1, as described above.

Furthermore, the above embodiment shows, as an example for the sensor mounting structure, the sensor mounting structure 1 in which the sensor lock portion 112a is locked to the receiving lock portion 124 by inserting the sensor main body 111 into the sensor insertion hole 123 and by subsequently rotating the sensor 110 in the rotational direction of locking D14. However, the sensor mounting structure is not limited thereto, but may have e.g. a structure in which the sensor lock portion is locked to the receiving lock portion simultaneously with insertion of the sensor main body into the sensor insertion hole. However, occurrences of mismounting can be reduced by a structure in which the sensor lock portion 112a is locked to the receiving lock portion 124 in two steps, i.e., a step of inserting the sensor main body 111 and a step of rotating it, as described above.

Furthermore, the above embodiment further shows, as an example for the sensor mounting structure, the sensor mounting structure 1 in which in the incorrect pose P12, the rotation of the sensor 110 in the rotational direction of locking D14 is limited by interference of the interference avoiding portion 112b with the receiving lock portion 124. However, the sensor mounting structure is not limited thereto, but may not have a particular configuration for limiting the rotation in the rotational direction of locking in the incorrect pose. However, occurrences of mismounting may be further reduced by the limitation of rotation of the sensor 110 in the incorrect pose P12, as described above.

Moreover, the above embodiment shows, as an example for the sensor lock portion, the sensor lock portion 112a having a cantilever shape, wherein the locking hook 112a-1 is formed at the free end of the cantilever shape, wherein the locking hook 112a-1 is configured to be locked to the receiving lock portion 124. However, the sensor lock portion is not limited thereto, but may have any specific locking structure for the sensor receiving section. However, occurrences of mismounting may be further reduced by the cantilever-shaped sensor lock portion 112a with the locking hook 112a-1 formed at the free end because such reduction can be achieved by perception of click generated by mounting the sensor 110 in the normal pose, as described above.

Moreover, the above embodiment shows, as examples for the locking hook and the receiving lock portion, the locking hook 112a-1 and the receiving lock portion 124 which include the sensor guide slope surface 112a-3 and the receiving guide slope surface 124a, respectively. However, the locking hook and the receiving lock portion are not limited thereto, but may have no slope surfaces at all which slide on each other during rotation of the sensor. However, workability related to mounting the sensor 110 can be further improved by the structure of the sensor guide slope surface 112a-3 and the receiving guide slope surface 124a which slide on each other during rotation of the sensor 110, as described above.

Furthermore, the above embodiment shows, as an example for the sensor mounting structure, the sensor mounting structure 1 in which the sensor main body 111 includes one pair of anti-removal protrusions 111e, and the sensor receiving section 120 includes one pair of protrusion passages 125 and one pair of accommodating spaces 127. The sensor mounting structure is not limited thereto, but the sensor main body may be configured without any anti-removal protrusions, and the sensor receiving section may be configured without any passages or accommodating spaces which correspond to the anti-removal protrusions. However, occurrences of mismounting may be further reduced by the sensor mounting structure 1 including the anti-removal protrusions 111e, protrusion passages 125 and accommodating spaces 127, whereby the sensor 110 can be mounted to the sensor receiving section 120 in a stable manner.

Further, the above embodiment shows, as an example for the sensor mounting structure, the sensor mounting structure 1 in which one pair of anti-removal protrusions 111e is spaced from each other by an angle of 180 degrees, wherein the incorrect pose P12 is an inverted pose which is offset from the normal pose P11 by an angle of 180 degrees. However, the sensor mounting structure is not limited thereto, but e.g. any number of anti-removal protrusions and/or any positional relationship of the incorrect pose to the normal pose may be appropriately selected, provided that at least one pair of anti-removal protrusions is provided. However, the sensor 110 may be prevented from being removed in a balanced manner by the sensor mounting structure 1 which includes one anti-removal protrusions 111e and the incorrect pose P12 as an inverted pose as described above, whereby occurrences of mismounting in the incorrect pose P12 may be further reduced, as described above.

### REFERENCE SIGNS LIST

1 Sensor mounting structure
2 Outer wall
110 Sensor
111 Sensor main body
111a Detecting section
111b Knob section
111c Middle section
111d Outer circumferential surface
111e anti-removal protrusions
112 Collar section
112a Sensor lock portion
112a-1 Locking hook
112a-2 Cut-in portion
112a-3 Sensor guide slope surface
112b Interference avoiding portion
112b-1 Recesses
120 Sensor receiving section
121 Tube main body portion
122 Seat surface portion
122a Seat surface
123 Sensor insertion hole
124 Receiving lock portion
124a Receiving guide slope surface
125 Protrusion passages
126 Partial seat surface walls
127 Accommodating spaces
D11 Direction of insertion
D12 Longitudinal direction
D13 Thickness direction
D14 Rotational direction of locking
P11 Normal pose
P12 Incorrect pose
X1 Center axis

What is claimed is:

1. A sensor mounting structure comprising:
a sensor including a bar-shaped sensor main body and a collar section, the collar section overhanging in a thickness direction of the sensor main body from an outer circumferential surface of the sensor main body at a middle location of the sensor main body in its longitudinal direction; and
a sensor receiving section including a sensor insertion hole, the sensor insertion hole being configured for inserting the sensor main body therein so as to allow the sensor main body to be rotated around a center axis of the sensor main body, wherein the sensor receiving section is configured to support the sensor with the sensor main body being inserted in the sensor insertion hole to bring the collar section into contact with a seat surface around the sensor insertion hole,
wherein the sensor receiving section includes a receiving lock portion protruding from the seat surface, the receiving lock portion being configured to be locked to a portion of the collar section,
wherein the collar section of the sensor includes:
a sensor lock portion configured to be locked to the receiving lock portion; and
an interference avoiding portion in an overlapping portion of the collar section, wherein when the sensor main body is inserted in the sensor insertion hole in an incorrect pose, the collar section is configured to overlap with the receiving lock portion in the overlapping portion, wherein the incorrect pose is offset from a normal pose by a predetermined angle around the center axis, wherein in the normal pose, the sensor lock portion is configured to be locked to the receiving lock portion, wherein the interference avoiding portion has a shape for avoiding interference of the collar section with the receiving lock portion along a direction of insertion of the sensor main body into the sensor insertion hole.

2. The sensor mounting structure according to claim 1,
wherein the interference avoiding portion of the collar section has a recess which is recessed from an outer circumference of the collar section toward the center axis of the sensor main body, and
wherein the recess is configured to receive the receiving lock portion inside the recess in the incorrect pose.

3. The sensor mounting structure according to claim 1,
wherein once the sensor main body is inserted in the sensor insertion hole with the sensor lock portion being spaced from the receiving lock portion around the center axis, the sensor is configured to be rotated in a rotational direction of locking to lock the sensor lock portion to the receiving lock portion and to thus reach the normal pose, wherein in the rotational direction of locking, the sensor lock portion is configured to be moved toward the receiving lock portion.

4. The sensor mounting structure according to claim 3,
wherein when the sensor main body is inserted in the sensor insertion hole in the incorrect pose, the interference avoiding portion is configured to limit rotation of the sensor in the rotational direction of locking by interfering with the receiving lock portion around the center axis.

5. The sensor mounting structure according to claim 3,
wherein the sensor lock portion has a cantilever shape which is formed by cutting into the collar section along an outer circumference of the collar section from a forward side to a backward side in the rotational direction of locking, the cantilever shape having a fixed end on the backward side and a free end on the forward side, and
wherein a locking hook is provided at the free end to be locked to the receiving lock portion, and
wherein when rotating the sensor in the rotational direction of locking, the sensor lock portion is configured to be bent toward the center axis so that the locking hook crosses over the receiving lock portion in order to be locked to the receiving lock portion.

6. The sensor mounting structure according to claim 5,
wherein guide slope surfaces are provided on a forward side of the locking hook on a backward side of the receiving lock portion in the rotational direction of locking respectively,
wherein when rotating the sensor in the rotational direction of locking, the guide slope surfaces are configured to slide on each other in order to guide the locking hook crossing over the receiving lock portion.

7. The sensor mounting structure according to claim 3,
wherein the sensor main body includes at least one pair of anti-removal protrusions located further forward in the direction of insertion than the collar section, the anti-removal protrusions protruding from the outer circumferential surface in the thickness direction,
wherein when the sensor has reached the normal pose by inserting the sensor main body into the sensor insertion hole and by rotating the sensor in the rotational direction of locking, the anti-removal protrusions are configured to serve for preventing removal by clamping a portion of the sensor receiving section between the anti-removal protrusions and the collar section,
wherein the sensor receiving section includes protrusion passages which are formed by cutting into the sensor receiving section radially outwardly from an inner circumferential edge of the sensor insertion hole,
wherein each of the protrusion passages is configured to allow one of the anti-removal protrusions when the sensor main body is inserted into the sensor insertion hole with the sensor lock portion being spaced from the receiving lock portion around the center axis,
wherein accommodating spaces for the anti-removal protrusions are provided on back sides of partial seat surface walls opposite to the seat surface such that in the normal pose, the partial seat surface walls are configured to be clamped between the collar section and the anti-removal protrusions, wherein each of the partial seat surface walls includes a portion adjacent to one of the protrusion passages on a forward side in the rotational direction of locking on the seat surface.

8. The sensor mounting structure according to claim 7,
wherein one pair of anti-removal protrusions is provided by being spaced from each other by an angle of 180 degrees around the center axis, and
wherein the incorrect pose is an inverted pose which is offset by an angle of 180 degrees from the normal pose around the center axis.
